(19) United States
(12) Patent Application Publication
(10) Pub. No.: US 2016/0005499 A1
(43) Pub. Date: Jan. 7, 2016

(54) METHODS OF COATING A NUCLEAR REACTOR COMPONENT WITH A COLLOIDAL SOLUTION

(71) Applicants: Yang-Pi LIN, Wilmington, NC (US); Young Jin KIM, Schenectady, NY (US); David William WHITE, Wilmington, NC (US); Garrett Scott NAVE, Wilmington, NC (US); Patricia P. MCCUMBEE, Wilmington, NC (US)

(72) Inventors: Yang-Pi LIN, Wilmington, NC (US); Young Jin KIM, Schenectady, NY (US); David William WHITE, Wilmington, NC (US); Garrett Scott NAVE, Wilmington, NC (US); Patricia P. MCCUMBEE, Wilmington, NC (US)

(73) Assignee: GE NUCLEAR ENERGY, Wilmington, NC (US)

(21) Appl. No.: 14/323,506

(22) Filed: Jul. 3, 2014

(51) Int. Cl. G21C 19/00; B05D 3/02; B05D 3/04; G21C 21/00; B05D 1/18

(52) U.S. Cl. CPC G21C 19/00; G21C 21/00; B05D 1/18; B05D 3/0406; B05D 3/0254

(57) ABSTRACT

A method of coating a nuclear reactor component includes introducing the nuclear reactor component into a colloidal solution at a first rate to obtain an immersed component. The colloidal solution is a non-crosslinked mixture including a dispersed phase within a dispersion medium. The dispersed phase may include n-type metal oxide particles. The method additionally includes removing the immersed component from the colloidal solution at a second rate to obtain a wet component. The method also includes drying the wet component to obtain a dried component. The method further includes baking the dried component to obtain a coated component. Accordingly, the nuclear reactor component is provided with a protective layer that reduces or prevents the occurrence of corrosion.

### BACKGROUND

1. Field

The present disclosure relates to methods of coating a nuclear reactor component so as to reduce or prevent corrosion. The coating of the nuclear reactor component involves a colloidal approach.

2. Description of Related Art

During the operation of a nuclear reactor, various components therein may experience corrosion over time. The corrosion may be in the form of shadow corrosion, which may result in fuel failure. To protect the components within the nuclear reactor that are vulnerable to corrosion, conventional approaches have been used to deposit a protective layer on such components. Typical deposition processes include, for instance, chemical vapor deposition (CVD). However, although a viable approach, forming a protective layer by chemical vapor deposition (CVD) can involve relatively high production costs.

### BRIEF DESCRIPTION OF EXAMPLE EMBODIMENTS

A method of coating a nuclear reactor component includes introducing the nuclear reactor component into a colloidal solution at a first rate to obtain an immersed component. The colloidal solution is a non-crosslinked mixture including a dispersed phase within a dispersion medium. The dispersed phase may include n-type metal oxide particles. The method additionally includes removing the immersed component from the colloidal solution at a second rate to obtain a wet component. The method also includes drying the wet component to obtain a dried component. The method further includes baking the dried component to obtain a coated component.

### BRIEF DESCRIPTION OF THE DRAWINGS

The various features and advantages of the non-limiting embodiments herein may become more apparent upon review of the detailed description in conjunction with the accompanying drawings. The accompanying drawings are merely provided for illustrative purposes and should not be interpreted to limit the scope of the claims. The accompanying drawings are not to be considered as drawn to scale unless explicitly noted. For purposes of clarity, various dimensions of the drawings may have been exaggerated.

FIG. 1 is a scanning electron microscope (SEM) image of a coated component with a relatively uniform coating based on the baking/annealing temperature according to an example embodiment.

FIG. 2 is a scanning electron microscope image of a coated component with a non-uniform coating based on the baking/annealing temperature according to a comparative embodiment.

FIG. 3 is a scanning electron microscope image of a coated component with a relatively uniform coating based on the drying time and heat up rate according to an example embodiment.

FIG. 4 is a scanning electron microscope image of a coated component with a non-uniform coating based on the drying time and heat up rate according to a comparative embodiment.

### DETAILED DESCRIPTION OF EXAMPLE EMBODIMENTS

It should be understood that when an element or layer is referred to as being “on,” “connected to,” “coupled to,” or “covering” another element or layer, it may be directly on, connected to, coupled to, or covering the other element or layer or intervening elements or layers may be present. In contrast, when an element is referred to as being “directly on,” “directly connected to,” or “directly coupled to” another element or layer, there are no intervening elements or layers present. Like numbers refer to like elements throughout the specification. As used herein, the term “and/or” includes any and all combinations of one or more of the associated listed items.

It should be understood that, although the terms first, second, third, etc. may be used herein to describe various elements, components, regions, layers and/or sections, these elements, components, regions, layers, and/or sections should not be limited by these terms. These terms are only used to distinguish one element, component, region, layer, or section from another region, layer, or section. Thus, a first element, component, region, layer, or section discussed below could be termed a second element, component, region, layer, or section without departing from the teachings of example embodiments.

Spatially relative terms (e.g., “beneath,” “below,” “lower,” “above,” “upper,” and the like) may be used herein for ease of description to describe one element or feature's relationship to another element(s) or feature(s) as illustrated in the figures. It should be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” may encompass both an orientation of above and below. The device may be otherwise oriented (rotated 90 degrees or at other orientations) and the spatially relative descriptors used herein interpreted accordingly.

The terminology used herein is for the purpose of describing various embodiments only and is not intended to be limiting of example embodiments. As used herein, the singular forms “a,” “an,” and “the” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments should not be construed as limited to the shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of example embodiments.

Unless otherwise defined, all terms (including technical and scientific terms) used herein have the same meaning as commonly understood by one of ordinary skill in the art to which example embodiments belong. It will be further understood that terms, including those defined in commonly used dictionaries, should be interpreted as having a meaning that is consistent with their meaning in the context of the relevant art and will not be interpreted in an idealized or overly formal sense unless expressly so defined herein.

According to the present disclosure, a protective layer may be formed on a component by utilizing a colloidal approach. In a non-limiting embodiment, the component may be a mechanical part that is used in a nuclear reactor. However, it should be understood that the present method is not limited to the context of a nuclear reactor but is intended to have other technological applications where the protection of a component is desired.

According to an example embodiment, a method of coating a nuclear reactor component includes introducing the nuclear reactor component into a colloidal solution. The nuclear reactor component may be a boiling water reactor (BWR) component, although example embodiments are not limited thereto. For instance, the nuclear reactor component may be a part of a fuel assembly (e.g., spacer, tie plate, control blade). The nuclear reactor component may also be formed of an iron-chromium-based alloy (e.g., stainless steel) or a nickel-chromium-based alloy (e.g., Inconel).

The colloidal solution is a non-crosslinked mixture including a dispersed phase within a dispersion medium. In particular, the non-crosslinked mixture neither includes a polymer network nor cross-linkable precursors that would form a polymer network at a later time. The colloidal solution is a stable system wherein the dispersed phase (e.g., solid particles) remains suspended within the dispersion medium (e.g., liquid). Being a stable system, the dispersed phase neither aggregate nor settle (or, conversely, float) in the dispersion medium. Instead, the colloidal solution is such that Brownian forces have a greater effect on the dispersed phase than gravitational forces, thereby keeping the dispersed phase suspended in the dispersion medium.

In an example, the dispersed phase includes n-type metal oxide particles. For instance, the n-type metal oxide particles may be n-type transition metal oxide particles. In a non-limiting embodiment, the n-type transition metal oxide particles may include at least one of TiO₂, Fe₂O₃, Cr₂O₃, ZrO₂, WO₃, ZnO, Ta₂O₃, MoO₃, and V₂O₃. The n-type metal oxide particles have an average size of less than 200 nm. For instance, the n-type metal oxide particles have an average size of less than 100 nm (e.g., less than 50 nm). The n-type metal oxide particles may also be of relatively high purity. For instance, the total amount of impurities within the n-type metal oxide particles may be less than 1% (e.g., less than 0.3%). The n-type metal oxide particles are present at a concentration of 5 to 35% based on a total weight of the colloidal solution.

The dispersion medium may be a water-based liquid. For instance, the dispersion medium may be an aqueous solution including a stabilizing agent. The stabilizing agent may be an acid, such as [2-(2-Methoxyethoxy)ethoxy]acetic acid, to prevent coagulation of the dispersed phase, although example embodiments are not limited thereto. The colloidal solution has a pH ranging from 2 to 3 (e.g., 2.3 to 2.8) for the example of [2-(2-Methoxyethoxy)ethoxy]acetic acid.

The nuclear reactor component is introduced into the colloidal solution at a first rate to obtain an immersed component. For instance, the introducing may include immersing the nuclear reactor component at a speed of 0.5 to 3 inches/minute as the first rate. The immersed component may be maintained (e.g., completely submerged) in the colloidal solution for 1 to 200 minutes (e.g., 45 to 75 minutes).

The method additionally includes removing the immersed component from the colloidal solution at a second rate to obtain a wet component. The removing may include withdrawing the immersed component at a speed of 0.5 to 3 inches/minute as the second rate.

The method also includes drying the wet component to obtain a dried component. The drying is performed for 30 to 300 minutes (e.g., 60 to 180 minutes). The wet component may be dried in air, although example embodiments are not limited thereto.

The method further includes baking (or annealing) the dried component to obtain a coated component. The baking may occur in a furnace. The baking is performed at a target temperature ranging from 300 to 700 degrees Celsius (e.g., 400 to 600 degrees Celsius) for densification of the particles into a coating layer. As a result, a thin layer of TiO₂, for example, may be coated on the nuclear reactor component. For instance, in terms of a thin layer, the weight gain for a coated component (e.g., spacer) with a surface area of about 2000 cm2 may be about 0.05 to 1.5 grams (e.g., about 1 gram), although example embodiments are not limited thereto. Furthermore, the resulting coating has a different appearance (e.g., transparent) compared to a conventional layer prepared by, for instance, chemical vapor deposition (CVD).

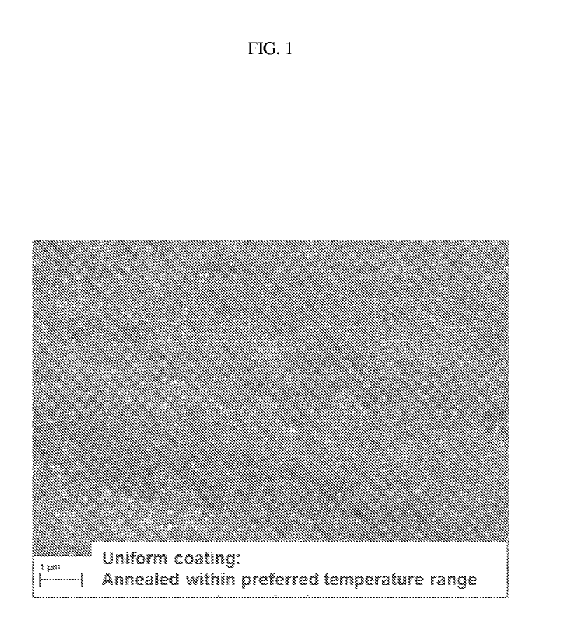

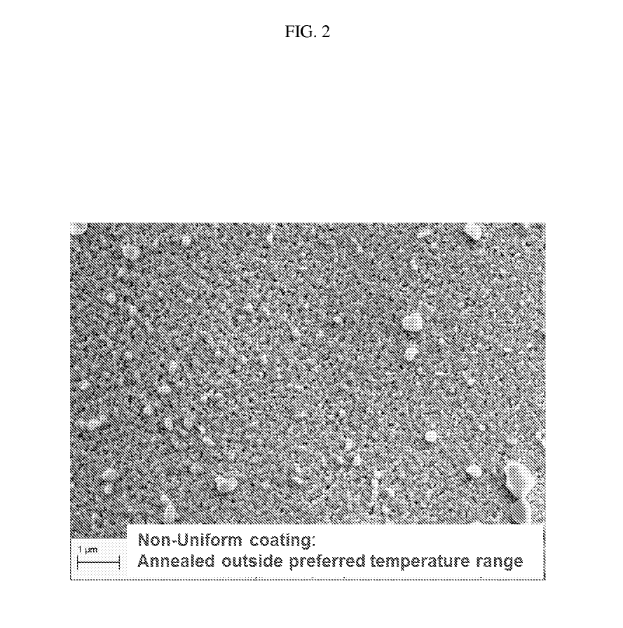

When the baking takes place between 300 to 700 degrees Celsius, a coated component with a relatively uniform coating may be obtained. FIG. 1 is a scanning electron microscope (SEM) image of a coated component with a relatively uniform coating based on the baking/annealing temperature according to an example embodiment. In contrast, when the baking does not take place between 300 to 700 degrees Celsius, a coated component with a non-uniform coating results. FIG. 2 is a scanning electron microscope image of a coated component with a non-uniform coating based on the baking/annealing temperature according to a comparative embodiment.

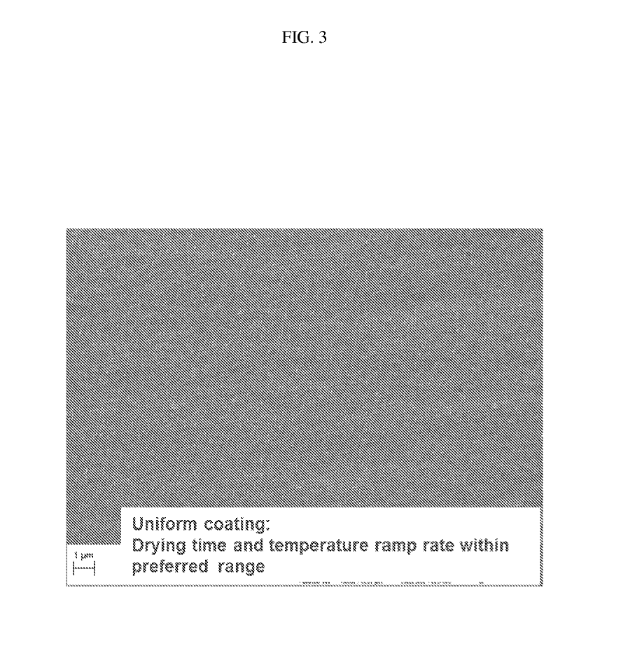

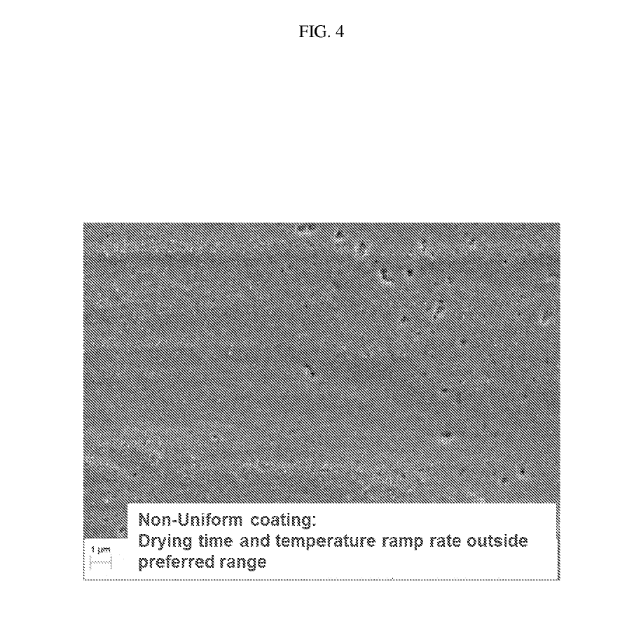

The baking includes heating up to the target temperature at a heat up rate of 1 to 20 degrees Celsius per minute (e.g., 8 to 12 degrees Celsius per minute). The dried component may be subjected to the target temperature for 15 to 300 minutes (e.g., 30 to 120 minutes). A heat up rate between 1 to 20 degrees Celsius per minute helps to provide a resulting coated component with a relatively uniform coating. A drying time of 30 to 300 minutes prior to the baking also helps to provide a resulting coated component with a more uniform coating. FIG. 3 is a scanning electron microscope image of a coated component with a relatively uniform coating based on the drying time and heat up rate according to an example embodiment. In contrast, when the drying time is not between 30 to 300 minutes prior to the baking and/or the heat up rate is not between 1 to 20 degrees Celsius per minute, a coated component with a non-uniform coating results. FIG. 4 is a scanning electron microscope image of a coated component with a non-uniform coating based on the drying time and heat up rate according to a comparative embodiment.

As discussed herein, nuclear reactor components may be coated with a protective layer in a relatively economical and reliable manner to reduce or prevent the occurrence of corrosion (e.g., shadow corrosion). The protective layer may also reduce or prevent erosion of the nuclear reactor component. In particular, erosion may present radiation dose issues in terms of cobalt (Co) release. In such situations, if erosion cannot be mitigated, then the potential materials for a component may be limited to those with relatively low amounts of cobalt in order to comply with radiation dose requirements. However, because components may be provided with a protective layer in a relatively economical and reliable manner with the present coating methods, materials with a higher cobalt content (e.g., Inconel, stainless steel) may be used since erosion can be reduced or prevented, thereby avoiding the radiation dose issues previously associated with unprotected components.

While a number of example embodiments have been disclosed herein, it should be understood that other variations may be possible. Such variations are not to be regarded as a departure from the spirit and scope of the present disclosure, and all such modifications as would be obvious to one skilled in the art are intended to be included within the scope of the following claims.

1. A method of coating a nuclear reactor component, comprising:
introducing the nuclear reactor component into a colloidal solution at a first rate to obtain an immersed component, the colloidal solution being a non-crosslinked mixture including a dispersed phase within a dispersion medium, the dispersed phase including n-type metal oxide particles;
removing the immersed component from the colloidal solution at a second rate to obtain a wet component;
drying the wet component to obtain a dried component; and
baking the dried component to obtain a coated component.

2. The method of claim 1, wherein the nuclear reactor component is a boiling water reactor (BWR) component.

3. The method of claim 1, wherein the nuclear reactor component is formed of an iron-chromium-based alloy or a nickel-chromium-based alloy.

4. The method of claim 1, wherein the n-type metal oxide particles are n-type transition metal oxide particles.

5. The method of claim 4, wherein the n-type transition metal oxide particles include at least one of TiO₂, Fe₂O₃, Cr₂O₃, ZrO₂, WO₃, ZnO, Ta₂O₃, MoO₃, and V₂O₃.

6. The method of claim 1, wherein the n-type metal oxide particles have an average size of less than 200 nm.

7. The method of claim 1, wherein the n-type metal oxide particles are present at a concentration of 5 to 35% based on a total weight of the colloidal solution.

8. The method of claim 1, wherein the dispersion medium is a water-based liquid.

9. The method of claim 1, wherein the non-crosslinked mixture does not include a polymer network.

10. The method of claim 1, wherein the colloidal solution has a pH ranging from 2 to 3.

11. The method of claim 1, wherein the introducing includes immersing the nuclear reactor component at a speed of 0.5 to 3 inches/minute as the first rate.

12. The method of claim 1, wherein the introducing includes maintaining the immersed component in the colloidal solution for 1 to 200 minutes.

13. The method of claim 1, wherein the removing includes withdrawing the immersed component at a speed of 0.5 to 3 inches/minute as the second rate.

14. The method of claim 1, wherein the drying is performed for 30 to 300 minutes.

15. The method of claim 1, wherein the baking is performed at a target temperature ranging from 300 to 700 degrees Celsius.

16. The method of claim 15, wherein the baking includes subjecting the dried component to the target temperature for 15 to 300 minutes.

17. The method of claim 15, wherein the baking includes heating up to the target temperature at a heat up rate of 1 to 20 degrees Celsius per minute.
